(19) United States
(12) Patent Application Publication
(10) Pub. No.: US 2025/0189912 A1
(43) Pub. Date: Jun. 12, 2025

(54) FIXING DEVICE AND IMAGE FORMING APPARATUS PROVIDED THEREWITH

(71) Applicant: KYOCERA Document Solutions Inc., Osaka (JP)

(72) Inventors: Koji TANIO, Osaka (JP); Seia FUJII, Osaka (JP)

(73) Assignee: KYOCERA Document Solutions Inc., Osaka (JP)

(21) Appl. No.: 18/972,033

(22) Filed: Dec. 6, 2024

(30) Foreign Application Priority Data
Dec. 12, 2023 (JP) 2023-209480

(51) Int. Cl. G03G 15/20

(52) U.S. Cl. CPC G03G 15/2032; G03G 15/2064

(57) ABSTRACT

A fixing device includes a fixing member, a housing that houses the fixing member, a side cover, a pressing mechanism, and a unit side gear, and fuses and fixes an unfixed toner image on a sheet passing through a fixing nip. The fixing member has a heated rotating member and a pressing rotating member in pressed contact therewith to form the fixing nip. The side cover is fitted to at least one longitudinal end of the housing. The pressing mechanism adjusts pressure between the heated and pressing rotating members. The unit side gear is coupled with a main body side gear provided on a main body of an image forming apparatus, and transmits a driving force to the fixing member or pressing mechanism. The side cover has a first positioning portion that positions the unit side gear and a second positioning portion that positions the main body side gear.

### INCORPORATION BY REFERENCE

This application is based on and claims the benefit of priority from Japanese Patent Application No. 2023-209480 filed on Dec. 12, 2023, the contents of which are hereby incorporated by reference.

### BACKGROUND

The present disclosure relates to fixing devices incorporated in image forming apparatuses such as multifunction peripherals, printers, facsimile machines, and multifunction peripherals having their functions integrated together, and to image forming apparatuses provided with such a fixing device.

In electrophotographic type image forming apparatuses, to fix a toner image to a sheet, wide use is made of a fixing device including a fixing member configured with a fixing roller or a fixing belt (a heated rotating member) and a pressing roller (a pressing rotating member) kept in pressed contact with each other. This fixing device passes the sheet through a fixing nip portion formed between the fixing roller or the fixing belt and the pressing roller, and heats and presses the toner image to fuse and fix the toner image to the sheet.

With the fixing device described above, the heated rotating member and the pressing rotating member are kept in pressed contact with each other, and this necessitates a configuration that can relieve the pressure for removal of the sheet when a jam occurs.

### SUMMARY

According to one aspect of the present disclosure, a fixing device includes a fixing member, a housing, a side cover, a pressing mechanism, and a unit side gear, and heats and presses a sheet passing through a fixing nip portion to fuse and fix an unfixed toner image on the sheet. The fixing member is configured with a heated rotating member and a pressing rotating member kept in pressed contact with the heated rotating member to form the fixing nip portion. The housing houses the fixing member. The side cover is fitted to at least one end of the housing in the longitudinal direction. The pressing mechanism adjusts the pressure between the heated rotating member and the pressing rotating member. The unit side gear is coupled with a main body side gear provided on a main body of an image forming apparatus, and transmits a driving force to the fixing member or the pressing mechanism. The side cover has a first positioning portion that positions the unit side gear and a second positioning portion that positions the main body side gear.

### BRIEF DESCRIPTION OF THE DRAWINGS

FIG. 1 is a schematic sectional view showing the overall construction of an image forming apparatus according to an embodiment of the present disclosure.

FIG. 2 is a part sectional view around a sheet conveyance passage and a duplex conveyance passage in the image forming apparatus according to the embodiment.

FIG. 3 is a perspective view of a fixing device as seen from downstream in the discharging direction of a transfer sheet from the image forming apparatus.

FIG. 4 is a side sectional view of the fixing device as cut at its middle in the longitudinal direction.

FIG. 5 is a side sectional view showing the configuration around a pressing mechanism in the fixing device.

FIG. 6 is a side view showing a state pressurize by the pressing mechanism.

FIG. 7 is a side view showing a state depressurized by the pressing mechanism.

FIG. 8 is a perspective view, as seen from inside, of a side cover of the fixing device.

FIG. 9 is a perspective view, as seen from outside, of the side cover of the fixing device.

FIG. 10 is a perspective view showing a state in which the side cover is fitted to a housing of the fixing device.

FIG. 11 is a diagram showing a state in which, from the state shown in FIG. 10, a depressurizing gear is fitted to a drive transmission shaft.

FIG. 12 is a perspective view showing a state in which the depressurizing gear and a depressurizing input gear are coupled together.

FIG. 13 is a perspective view showing a state in which a driving input gear and a driving output gear are coupled together.

FIG. 14 is a side sectional view showing a state in which the driving input gear and a roller driving gear are coupled together.

### DETAILED DESCRIPTION

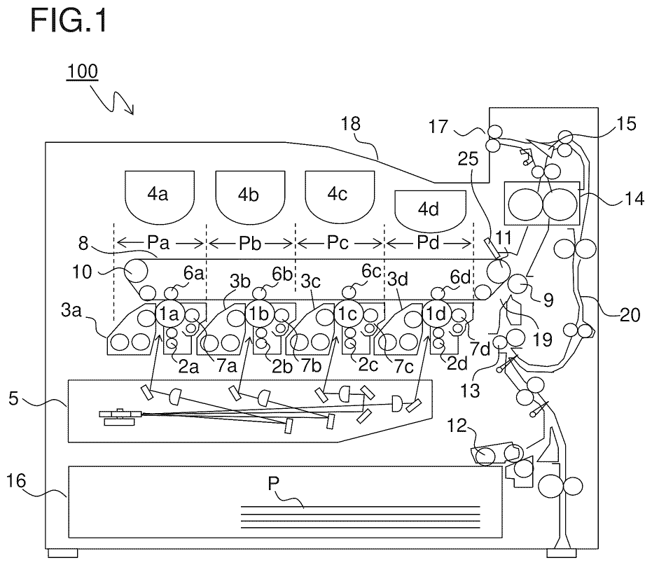

Hereinafter, an embodiment of the present disclosure will be described with reference to the drawings. FIG. 1 is a sectional view showing the internal construction of an image forming apparatus 100 according to an embodiment of the present disclosure. In a main body of the image forming apparatus 100 (here, a color printer), four image forming portions Pa, Pb, Pc, and Pd are arranged in this order from upstream (the left side in FIG. 1) in the conveyance direction. The image forming portions Pa to Pd are provided so as to correspond to images of four different colors (yellow, cyan, magenta, and black). The image forming portions Pa to Pd form yellow, cyan, magenta, and black images sequentially, each through the processes of electrostatic charging, exposure to light, image development, and image transfer.

In these image forming portions Pa to Pd are arranged photosensitive drums (image carrying member) 1a, 1b, 1c, and 1d, which carry visible images (toner images) of the different colors. An intermediate transfer belt (intermediate transfer member) 8 that rotates counterclockwise in FIG. 1 by being driven by a belt driving motor (not illustrated) is provided adjacent to the image forming portions Pa to Pd. The toner images formed on the photosensitive drums 1a to 1d are, by being primarily transferred sequentially to the intermediate transfer belt 8, which moves while in contact with the photosensitive drums 1a to 1d, overlaid on each other. Thereafter, the toner images primarily transferred to the intermediate transfer belt 8 are secondarily transferred by a secondary transfer roller 9 to a transfer sheet P as one example of a recording medium. The transfer sheet P having the toner images secondarily transferred to it then has the toner images fixed to it in a fixing device 14 and is then discharged out of the main body of the image forming apparatus 100. While the photosensitive drums 1a to 1d are rotated clockwise in FIG. 1, an image forming process is performed with respect to the photosensitive drums 1a to 1d.

The transfer sheets P to which toner images will be secondarily transferred are stored inside a sheet cassette 16 arranged in a lower part of the main body of the image forming apparatus 100. The transfer sheet P is conveyed via a sheet feed roller 12 and a pair of registration rollers 13 along a sheet conveyance passage 19 to the nip between the secondary transfer roller 9 and a driving roller 11 for the intermediate transfer belt 8. Used as the intermediate transfer belt 8 is a sheet of a dielectric resin, typically a belt with no seam (a seamless belt). Downstream of the secondary transfer roller 9, a blade-form belt cleaner 25 for removing toner and the like left on the surface of the intermediate transfer belt 8 is provided.

Next, the image forming portions Pa to Pd will be described. Around and under the photosensitive drums 1a to 1d, which are rotatably arranged, there are provided charging devices 2a, 2b, 2c, and 2d which electrostatically charge the photosensitive drums 1a to 1d, an exposure device 5 which exposes the photosensitive drums 1a to 1d to light conveying image information, developing device 3a, 3b, 3c, and 3d which form toner images on the photosensitive drums 1a to 1d, and cleaning devices 7a, 7b, 7c, and 7d which remove developer (toner) and the like left on the photosensitive drums 1a to 1d.

When image data is fed in from a host device such as a personal computer, first, the charging devices 2a to 2d electrostatically charge the surfaces of the photosensitive drums 1a to 1d uniformly. Next, the exposure device 5 irradiates the photosensitive drums 1a to 1d with light according to image data to form on them electrostatic latent images according to the image data. The development devices 3a to 3d are loaded with predetermined amounts of two-component developer containing toner of different colors, namely yellow, cyan, magenta, and black respectively. When, as image formation proceeds as will be described later, the proportion of the toner in the two-component developer in the development devices 3a to 3d falls below a prescribed value, toner is supplied from toner containers 4a to 4d to the development devices 3a to 3d. The toner in the developer is fed from the development devices 3a to 3d to the photosensitive drums 1a to 1d and electrostatically adhere to them. Thus, toner images are formed according to the electrostatic latent images formed by exposure to light from the exposure device 5.

Then, primary transfer rollers 6a to 6d apply an electric field at a predetermined transfer voltage between the primary transfer rollers 6a to 6d and the photosensitive drums 1a to 1d, and thereby the yellow, cyan, magenta, and black toner images on the photosensitive drums 1a to 1d are primarily transferred to the intermediate transfer belt 8. These images are formed with a predetermined positional relationship. After that, in preparation for the subsequent formation of new electrostatic latent images, the toner and the like remaining on the surfaces of photosensitive drums 1a to 1d after primary transfer are removed by cleaning devices 7a to 7d.

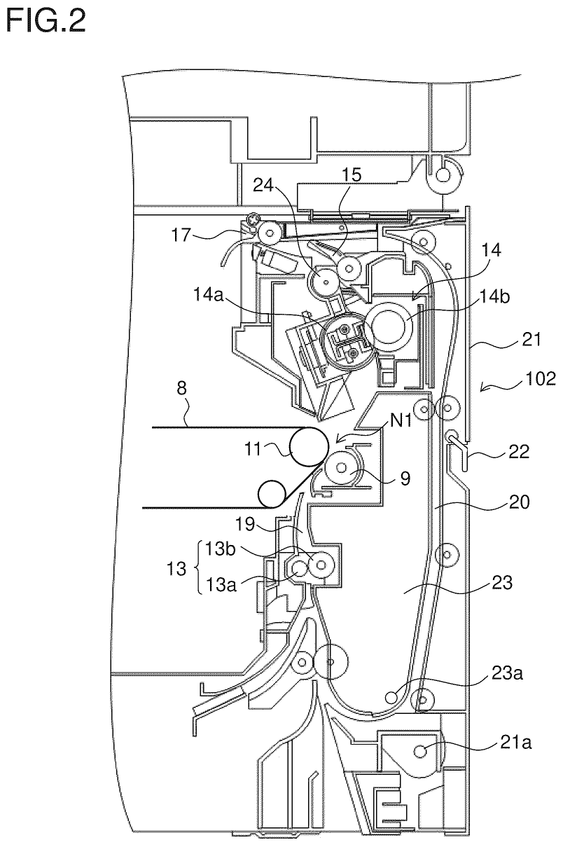

The intermediate transfer belt 8 is wound around a driven roller 10, arranged upstream, and the driving roller 11, arranged downstream. As the driving roller 11 is rotated by the belt driving motor (not illustrated), the intermediate transfer belt 8 starts rotating counterclockwise, and the transfer sheet P is conveyed with predetermined timing from the pair of registration rollers 13 to a secondary transfer nip portion N1 (see FIG. 2) between the driving roller 11 and the secondary transfer roller 9 provided next to it. The toner images formed on the intermediate transfer belt 8 are secondarily transferred to the transfer sheet P passing through the secondary transfer nip portion N1.

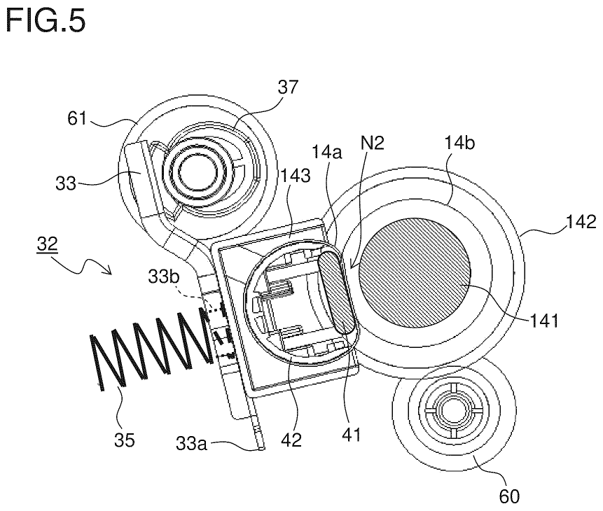

The transfer sheet P having the toner images secondarily transferred to it is conveyed to the fixing device 14. The fixing device 14 has a fixing belt 14a and a pressing roller 14b (see FIG. 2 for both). The fixing belt 14a is heated with a heater (not illustrated). The pressing roller 14b is kept in pressed contact with the fixing belt 14a to form a fixing nip N2 (see FIG. 5) and applies a rotational driving force to the fixing belt 14a. Instead of the heater, an induction heating portion may be provided on the outside of the fixing belt 14a.

The transfer sheet P conveyed to the fixing portion 14 is heated and pressed by the fixing belt 14a and the pressing roller 14b; thus the toner images are fixed to the surface of the transfer sheet P and a predetermined full-color image is formed. The transfer sheet P with the full-color image formed on it is conveyed via a pair of fixing discharge rollers 24 (see FIG. 2) and then has its conveyance direction switched by a branch portion 15 that branches into a plurality of directions so as to be discharged as it is (or after being diverted to a duplex conveyance passage 20 to have images formed on both sides) to a discharge tray 18 by a pair of discharge rollers 17.

FIG. 2 is a part sectional view around the sheet conveyance passage 19 and the duplex conveyance passage 20 in the image forming apparatus 100 according to this embodiment. An open/close cover 21 constitutes part of a side face 102 of the image forming apparatus 100 and is pivotably supported on a cover shaft 21a provided in the lower part of the main body of the image forming apparatus 100. The inner side face of the open/close cover 21 constitutes part of one (outside) of the conveyance faces of the duplex conveyance passage 20.

The side face of the open/close cover 21 is provided with a grip portion 22. The grip portion 22 keeps the open/close cover 21 closed with one end part of the grip portion 22 engaging with engagement pins (not illustrated) provided on a front frame and a rear frame of the main body of the image forming apparatus 100. To open the open/closed cover 21, the grip portion 22 is pivoted to disengage from the engagement pins.

Inward of the open/close cover 21 is arranged a conveyance unit 23. The conveyance unit 23 is supported on the main body of the image forming apparatus 100 so as to be pivotable about a unit shaft 23a and the conveyance unit 23 constitutes part of the conveyance face of the duplex conveyance passage 20 and the sheet conveyance passage 19. The duplex conveyance passage 20 extends between the inner side surface of the open/close cover 21 and the outer side surface of the conveyance unit 23 along the side face 102 of the image forming apparatus 100 in the up-down direction, then curves substantially in a C-shape to join the sheet conveyance passage 19. The inner side surface of the conveyance unit 23 is fitted with, in order from upstream (bottom in FIG. 2) in the conveyance direction of the transfer sheet P, a one-side roller 13b, which together with a main-body-side roller 13a constitutes the pair of registration rollers 13, and the secondary transfer roller 9.

As the open/close cover 21 alone is pivoted to open in the opening direction with respect to the image forming apparatus 100, the duplex conveyance passage 20 is exposed over a wide range. As the open/close cover 21 is pivoted together with the conveyance unit 23 in the opening direction, the conveyance unit 23 moves away from the main body of the image forming apparatus 100 and the sheet conveyance passage 19 is exposed over a wide range. By contrast, as the open/close cover 21 is pivoted together with the conveyance unit 23 to close in the closing direction, the conveyance unit 23 makes contact with the main body of the image forming apparatus 100, the secondary transfer roller 9 is pressed against the driving roller 11 with the intermediate transfer belt 8 in between to form a secondary transfer nip N1.

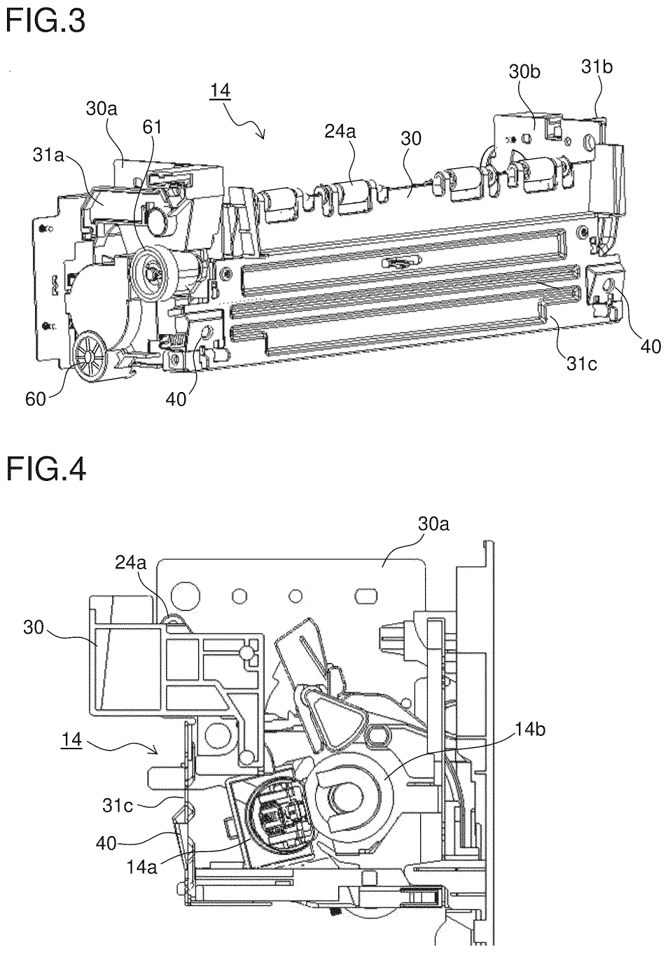

Next, the configuration of the fixing device 14 will be described. FIG. 3 is a perspective view, as seen from the downstream side (left side in FIG. 2) in the discharging direction of the transfer sheet P from the image forming apparatus 100, of the fixing device 14. FIG. 4 is a side sectional view of the fixing device 14 as cut at its middle in the longitudinal direction.

The fixing device 14 has a housing 30, side covers 31a and 31b, and a stay 31c. The housing 30 houses the fixing belt 14a and the pressing roller 14b. Above the housing 30 is supported one-side (left side in FIG. 2) roller 24a constituting the pair of fixing discharge rollers 24.

The side covers 31a and 31b are fixed to side plates 30a and 30b arranged at the opposite ends of the housing 30 in the longitudinal direction. The stay 31c is made of metal and is a plate-form member fixed to the housing 30 along the longitudinal direction. At the opposite ends of the stay 31c in the longitudinal direction, a pair of spring brackets 40 are formed, each to support one end (lower end) of a pressing spring 35 (see FIG. 5) of a pressing mechanism 32.

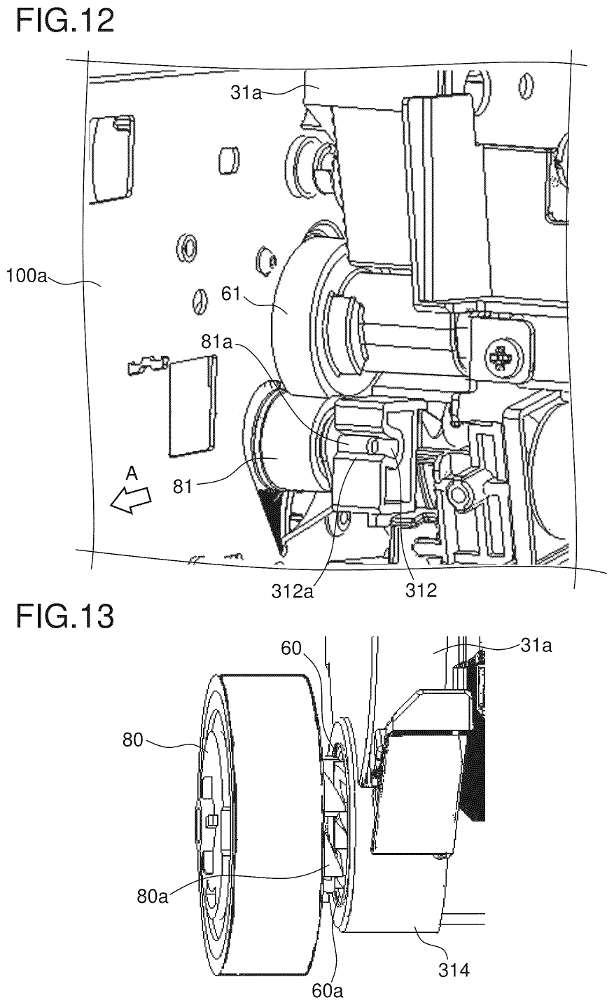

At the side cover 31a side, there are arranged a driving input gear 60 and a depressurizing gear 61. The driving input gear 60 meshes with a roller driving gear 142 (see FIG. 5) fixed to a rotation shaft 141 of the pressing roller 14b. When a rotational driving force is transmitted from a fixing driving motor (not illustrated) via a driving output gear 80 (see FIG. 13) on the main body of the image forming apparatus 100 to the driving input gear 60, the pressing roller 14b rotates at a predetermined speed. Thus, the fixing belt 14a kept in pressed contact with the fixing roller 14b also rotates by following the pressing roller 14b.

FIG. 5 is a side view showing the configuration around the pressing mechanism 32 in the fixing device 14. On the shaft 141 of the pressing roller 14b, the roller driving gear 142 is fixed. The roller driving gear 142 is coupled with the driving input gear 60.

Inside the fixing belt 14a are arranged a nip forming member 41 and a belt guide 42. The nip forming member 41 makes contact with the pressing roller 14b via the fixing belt 14a to form a fixing nip portion N2 through which the transfer sheet P is inserted. The nip forming member 41 is made of a heat-resistant resin such as a liquid crystal polymer or an elastic material such as silicone rubber and an elastomer may be arranged on the surface facing the fixing belt 14a for enhanced sliding properties.

The belt guide 42 is in the shape of an arc in a sectional view and makes contact with the inner circumferential surface of the fixing belt 14a except on the surface facing the nip forming member 41. The belt guide 42 applies a predetermined tension to the fixing belt 14a and holds the fixing belt 14a in the shape of an arc from inside it. The belt guide 42 is formed of a metal plate that extends along the axial direction of the fixing belt 14a over substantially the same length as the fixing belt 14a.

A pair of pressing mechanisms 32 are provided at the opposite ends of the fixing belt 14a and the pressing roller 14b in the axial direction. Each pressing mechanism 32 has a pressing plate 33, a pressing spring 35, and an eccentric cam 37.

The pressing plate 33 is arranged opposite belt holder 143 that supports the opposite ends of the fixing belt 14a, the nip forming member 41, and the belt guide 42 in the longitudinal direction. The pressing plate 33 has a fulcrum portion 33a supported on the housing 30 (see FIG. 3) of the fixing device 13 and is swingable in directions toward and away from the belt holder 143.

The pressing spring 35 urges the belt holder 143 in a direction toward the pressing roller 14b. Specifically, one end of the pressing spring 35 is supported in the spring bracket 40 (see FIG. 3) formed in the stay 31c. The other end of the pressing spring 35 is fitted around a boss (not illustrated) on the belt holder 143 that projects through a through-hole 33b formed in the pressing plate 33 and is in contact with the pressing plate 33. The inner diameter of the through-hole 33b is smaller than the outer diameter of the pressing spring 35 and as the pressing plate 33 swings, the pressing spring 35 stretch and contracts between the pressing plate 33 and the spring bracket 40.

The eccentric cam 37 is arranged at the same side (right side in FIG. 5) as the belt holder 143 with respect to the pressing plate 33. The eccentric cam 37 is formed integrally with the depressurizing gear 61 that feeds the driving force to the pressing mechanism 32. As the eccentric cam 37 rotates together with the depressurizing gear 61, a change occurs in the outer diameter of the eccentric cam 37 that makes contact with the pressing plate 33.

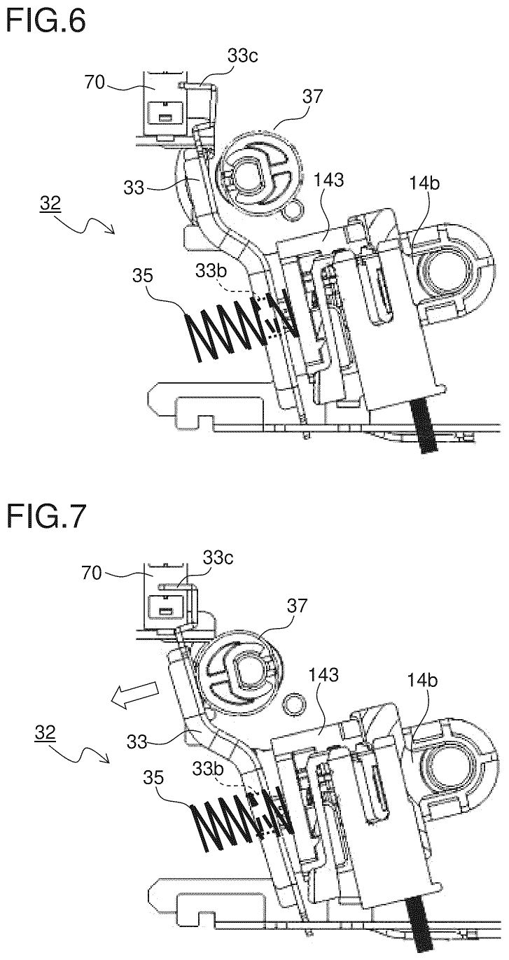

FIGS. 6 and 7 are side views showing a pressurized state and a depressurized state, respectively, of the pressing mechanism 32. As shown in FIG. 6, when a small-diameter portion of the eccentric cam 37 faces the pressing plate 33, the urging force of the pressing spring 35 causes a constant pressure to act on the belt holder 143. Thus, the pressing roller 14b is kept in pressed contact with the nip forming member 41 to form the fixing nip N2 (see FIG. 5) with the fixing belt 14a. In the state in FIG. 6, a light-shielding portion 33c formed on the swinging end of the pressing plate 33 is retracted from a sensing portion of a PI sensor 70 and the PI sensor 70 senses the pressurized state.

When the eccentric cam 37 rotates a predetermined amount from the state in FIG. 6 and, as shown in FIG. 7, a large-diameter portion of the eccentric cam 37 makes contact with the pressing plate 33, the pressing plate 33 is pressed against the urging force of the pressing spring 35 in a direction away from the belt holder 143. As a result, the pressing spring 35 is compressed between the pressing plate 33 and the spring bracket 40 and the pressure acting from the pressing plate 33 to the belt holder 143 is weakened. In the state in FIG. 7, the light-shielding portion 33c shields from light the sensing portion of the PI sensor 70 and the PI sensor 70 senses the depressurized state.

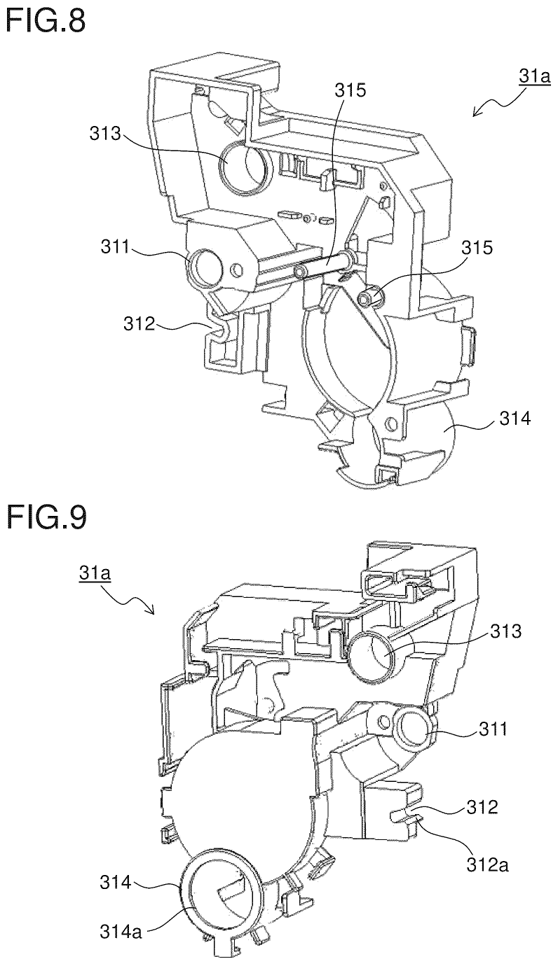

FIGS. 8 and 9 are perspective views, as seen from inside and outside respectively, of the side cover 31a of the fixing device 14. The side cover 31a is mounted on one end side (left side in FIG. 3) of the housing 30 and constitutes part of the exterior surface of the fixing device 14. In the side cover 31a are formed a first bearing portion 311, a second bearing portion 312, a third bearing portion 313, a gear cover portion 314, and a positioning pin 315.

The first bearing portion 311 is a circular through-hole in which is inserted a drive transmission shaft 61a (see FIG. 10) of the depressurizing gear 61 in the pressing mechanism 32. The inner diameter of the first bearing portion 311 is slightly larger than the diameter of the drive transmission shaft 61a. The first bearing portion 311 rotatably supports the drive transmission shaft 61a and positions the drive transmission shaft 61a.

The second bearing portion 312 is a U-shaped groove with a cutout portion 312a formed in part of the circumference of a through-hole in a cylindrical shape. In the second bearing portion 312 is inserted a rotation shaft 81a (see FIG. 12) of a depressurizing input gear 81 on the main body of the image forming apparatus 100. The second bearing portion 312 rotatably supports the rotation shaft 81a and positions the rotating shaft 81a.

The third bearing portion 313 is a circular through-hole in which is inserted a coupling (not illustrated) that drives the roller 24a (see FIG. 3) constituting the pair of fixing discharge rollers 24. The third bearing portion 313 rotatably supports the coupling that drives the roller 24a and also positions the coupling.

The gear cover portion 314 is in a cylindrical shape and covers the driving input gear 60 (see FIG. 5) from outside. The inner diameter of the gear cover portion 314 is slightly larger than the diameter of the driving input gear 60. In the gear cover portion 314 is formed a circular opening 314a. The side face (coupling face) of the driving input gear 60 is exposed through the opening 314a to allow the driving input gear 60 to be coupled to the driving output gear 80 (see FIG. 13) on the main body of the image forming apparatus 100.

The positioning pin 315 is inserted into a positioning hole (not illustrated) in the side plate 30a (see FIG. 3) of the housing 30 when the side cover 31a is fitted to the housing 30. This positions the side cover 31a relative to the side plate 30a.

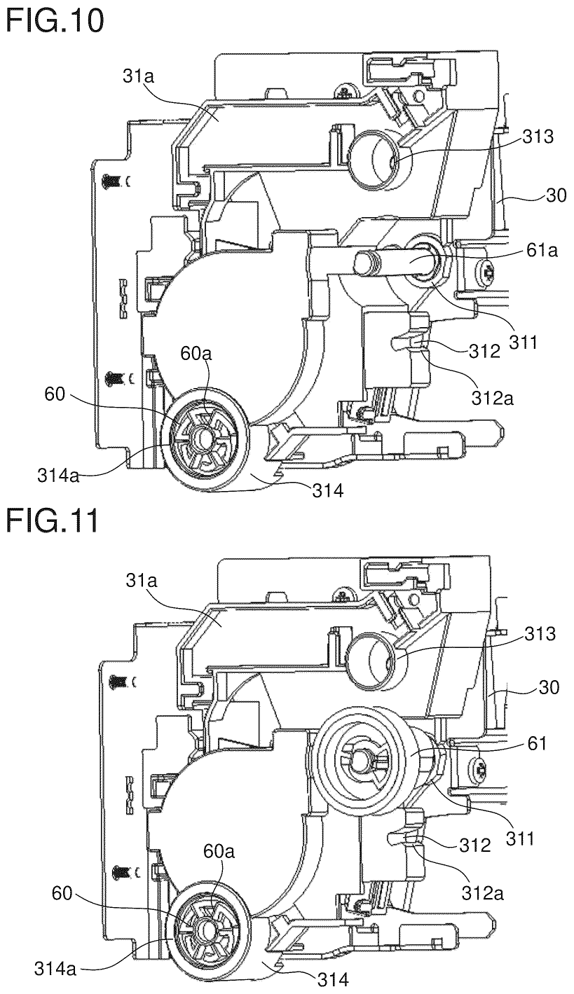

FIG. 10 is a perspective view showing a state in which the side cover 31a is fitted to the housing 30 of the fixing device 14. FIG. 11 is a diagram showing a state in which, from the state shown in FIG. 10, the depressurizing gear 61 is fitted to the drive transmission shaft 61a. When the side cover 31a is fitted to the housing 30, the drive transmission shaft 61a is inserted into the first bearing portion 311, the driving input gear 60 is inserted into the gear cover portion 314, and the positioning pin 315 (see FIG. 8) formed on the inner face of the side cover 31a is inserted into the positioning hole (not illustrated) formed in the side plate 30a of the housing 30.

Thus, the first bearing portion 311 in the side cover 31a and the driving transmission shaft 61a on the housing 30 are positioned with each other. The driving transmission shaft 61a has a D-cut shaped section and supports the depressurizing gear 61 such that this is movable in the thrust direction but not rotatable in the circumferential direction.

The depressurizing gear 61 is coupled with the depressurizing gear 61 at the other side (side cover 31b side) by the driving transmission shaft 61a. A rotational driving force fed from the depressurizing input gear 81 to the depressurizing gear 61 is transmitted via the drive transmission shaft 61a to the depressurizing gear 61 and the eccentric cam 37 at the other side.

The gear cover portion 314 in the side cover 31a and the driving input gear 60 in the housing 30 are positioned with each other and the driving input gear 60 is housed in the gear cover portion 314. On the side face of the driving input gear 60 (the face facing the driving output gear 80) input coupling teeth 60a are formed. The input coupling teeth 60a are exposed through the opening 314a in the gear cover portion 314.

FIG. 12 is a perspective view showing a state in which the depressurizing gear 61 and the depressurizing input gear 81 are coupled together. On a side frame 100a of the image forming apparatus 100 facing the side cover 31a are arranged the driving output gear 80 (see FIG. 13) and the depressurizing input gear 81.

When the fixing device 14 is mounted in the main body of the image forming apparatus 100, the open/close cover 21 (see FIG. 2) on the image forming apparatus 100 is opened and the fixing device 14 is inserted in the horizontal direction (from right to left in FIG. 2).

As the fixing device 14 is inserted, as shown in FIG. 12, the rotation shaft 81a of the depressurizing input gear 81 is inserted into the second bearing portion 312 in the side cover 31a. More specifically, through the cutout portion 312a in the second bearing portion 312, which has a U-shaped groove, the rotation shaft 81a is radially inserted. Thus, the depressurizing input gear 81 is positioned relative to the side cover 31a. The driving transmission shaft 61a (FIG. 10) of the depressurizing gear 61 is inserted in the first bearing portion 311, so the depressurizing gear 61 is also positioned relative to the side cover 31a. That is, both the depressurizing gear 61 and the depressurizing input gear 81 are positioned relative to the side cover 31a.

FIG. 13 is a perspective view showing a state in which the driving input gear 60 and the driving output gear 80 are coupled together. As shown in FIG. 13, on the side frame 100a (see FIG. 12), the driving output gear 80 is arranged. On the side face of the driving output gear 80 (the face facing the driving input gear 60), output coupling teeth 80a are formed. The driving output gear 80 is movable in the thrust direction relative to the side frame 100a and is urged inward of the side frame 100a with a spring (not illustrated).

As shown in FIG. 12, when the side cover 31a is placed so as to face the side frame 100a and the depressurizing gear 61 and the depressurizing input gear 81 are coupled together, the driving output gear 80 faces the driving input gear 60 on the fixing device 14. Then, as shown in FIG. 13, the output coupling teeth 80a on the driving input gear 80 and the input coupling teeth 60a on the driving input gear 60 mesh with each other in the thrust direction to transmit a rotational driving force from the driving output gear 80 to the driving input gear 60.

With the configuration described above, the positioning accuracy between the depressurizing gear 61 on the fixing device 14 and the depressurizing input gear 81 on the main body of the image forming apparatus 100 is improved and the inter-axial distance (gear pitch) is kept constant; this helps prevent meshing failure (tooth skipping) on the depressurizing gear 61 and the depressurizing input gear 81 and prevent abnormal noise.

Only with the side cover 31a, the depressurizing gear 61 and the depressurizing input gear 81 can be positioned relative to each other, and this helps reduce the number of the components of the fixing device 14. It is thus possible to reduce the size and the weight of the fixing device 14.

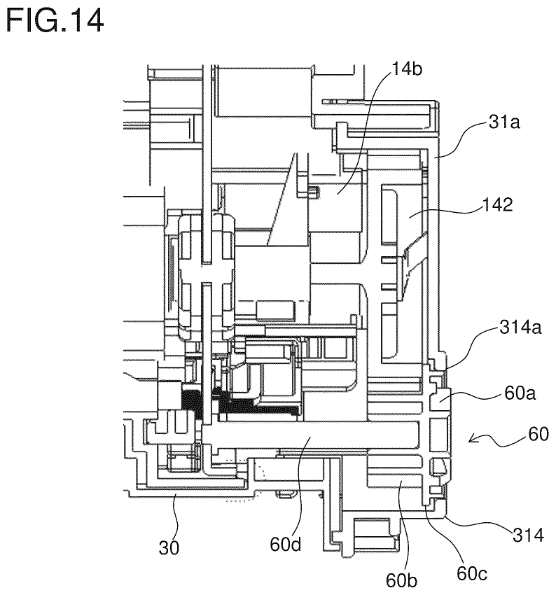

FIG. 14 is a side sectional view showing a state in which the driving input gear 60 and the roller driving gear 142 are coupled together. On the outer circumferential surface of the driving input gear 60 are formed gear teeth 60b that mesh with the roller driving gear 142. Between the input coupling teeth 60a and the gear teeth 60b is formed a ring-shaped flange portion 60c. The gear cover portion 314 holds the driving input gear 60 with the circumferential edge of the opening 314a engaging with the flange portion 60c.

As shown in FIG. 14, the gear cover portion 314 of the side cover 31a positions the driving input gear 60; thus, through the engagement of the second bearing portion 312 with the rotation shaft 81a of the depressurizing input gear 81, the driving input gear 60 on the fixing device 14 and the driving output gear 80 on the main body of the image forming device 100 are also positioned indirectly with the side cover 31a. As a result, the positioning accuracy of the driving input gear 60 and the driving output gear 80 is also improved.

The shaft 60d of the driving input gear 60 has a long protruding length relative to the housing 30 and so is prone to axis inclination. The gear cover portion 314 holding the driving input gear 60 also helps prevent axis inclination of the shaft 60d.

The present disclosure is not limited to the above embodiment and can be carried out with any modifications made without departure from the spirit of the present disclosure. For example, while the above embodiment takes up as an example a belt heating-type fixing device 14 that includes an endless fixing belt 14a as a heated rotating member, the present disclosure is applicable also to fixing devices including a heated rotating member other than a fixing belt 14a, such as a fixing roller.

While the embodiment described above deals with, as an example of an image forming apparatus 100, a color printer as shown in FIG. 1, the present disclosure is applicable not only to color printers but also to any image forming apparatuses including a fixing device, such as color copiers, color multifunction peripherals, monochrome printers, and monochrome copiers.

The present disclosure finds applications in fixing devices incorporated in image forming apparatuses such as copiers, printers, facsimile machines, and multifunction peripherals having their functions integrated together. Based on the present disclosure, it is possible to enhance the positioning accuracy of a driving member with a simple configuration and to provide a fixing device that can prevent problems such as coupling failure and abnormal noise caused by displacement of a coupling portion, and to provide an image forming apparatus provided with such a fixing device.

What is claimed is:

1. A fixing device comprising:
a fixing member configured with a heated rotating member and a pressing rotating member kept in pressed contact with the heated rotating member to form a fixing nip portion;
a housing that houses the fixing member;
a side cover fitted to at least one end of the housing in a longitudinal direction;
a pressing mechanism that adjusts pressure between the heated rotating member and the pressing rotating member; and
a unit side gear that is coupled with a main body side gear provided on a main body of an image forming apparatus, the unit side gear transmitting a driving force to the fixing member or the pressing mechanism,
wherein
the side cover has
a first positioning portion that positions the unit side gear and
a second positioning portion that positions the main body side gear, and
the fixing device heats and presses a sheet passing through the fixing nip portion to fuse and fix an unfixed toner image on the sheet.

2. The fixing device according to claim 1, wherein
the second positioning portion positions the main body side gear coupled with the unit side gear positioned by the first positioning portion.

3. The fixing device according to claim 2, wherein
the unit side gear is a depressurizing gear that transmits the driving force to the pressing mechanism to relieve the pressure,
the main body side gear is a depressurizing input gear that is coupled with the depressurizing gear, and
the first positioning portion is a first bearing portion that rotatably supports a driving transmission shaft on which the depressurizing gear is fitted.

4. The fixing device according to claim 3, wherein
the second positioning portion is a second bearing portion that rotatably supports a rotation shaft of the depressurizing input gear.

5. The fixing device according to claim 4, wherein
the fixing device is inserted in a direction orthogonal to the rotation shaft of the depressurizing gear with respect to the image forming apparatus, and
the second positioning portion is a groove U-shaped as seen in a side view that has a cutout portion in a downstream part thereof in an insertion direction of the fixing device.

6. The fixing device according to claim 1, wherein
the unit side gear is a driving input gear that transmits a rotational driving force to the fixing member, and
the first positioning portion is a gear cover portion that covers an outer circumferential surface of the driving input gear.

7. An image forming apparatus comprising:
an image forming portion that forms a toner image on a recording medium, and
the fixing device according to claim 1 that heats and presses the recording medium having the toner image formed by the image forming portion, to fix the toner image to the recording medium.
